(19) United States
(12) Patent Application Publication
(10) Pub. No.: US 2009/0006594 A1
(43) Pub. Date: Jan. 1, 2009

(54) Method and system for remote manageability of networked computers

(76) Inventors: Avigdor Eldar, Jerusalem (IL); Adi Shaliv, Moshav Nir-Banim (IL); Asaf Haskel, Jerusalem (IL); Carey Smith, Hillsboro, OR (US); Johan Van De Groenendaal, Portland, OR (US)

Correspondence Address: PEARL COHEN ZEDEK LATZER, LLP, 1500 BROADWAY, 12TH FLOOR, NEW YORK, NY, 10036, US

(21) Appl. No.: 11/819,505

(22) Filed: Jun. 27, 2007

(51) Int. Cl. G06F 15/173

(52) U.S. Cl. 709/223

(57) ABSTRACT

A method and system may allow a management server in a first network to communicate via a mediator server with a management module of a computing system in a second network. The mediator server may establish a communication connection to the management module and the data transferred from the management server to the management module may be associated with the communication connection.

### BACKGROUND OF THE INVENTION

The need for control and manageability over networked computers while reducing costly technical assistant visits and asset tracking is well known. Current systems enable system managers, for example, Information Technology (IT) managers to remotely discover and repair computer problems that previously required service visits. Existing solutions enable communication with devices or computers located in the same local area network, for example, an intranet local area network of the management device. An IT manager may remotely set up new computers, download software updates, perform asset inventories and find and fix many problems within a local area network. Such functions may be possible even when target systems are turned off, the operating system has locked up or the hard drive has failed.

Recently there is an increasing use of remote connection between users' computers and corporate networks, such as for example, an employee working from home, a laptop user connecting to a business network and the like. A solution which may allow control and manageability of devices located outside the local area network is desired.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic block diagram of a manageability system according to an embodiment of the present invention;

FIG. 2 is a sequence diagram of remote manageability flow according to an embodiment of the present invention;

FIGS. 3A and 3B are a sequence diagram of remote flow manageability according to an embodiment of the present invention; and

FIGS. 4A and 4B are a sequence diagram of remote flow control manageability according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like. For example, “plurality of mobile stations” describes two or more mobile stations.

It should be understood that embodiments of the present invention may be used in a variety of applications. Although the present invention is not limited in this respect, the techniques and modules disclosed herein may be used in many apparatuses such as personal computers (PCs), laptop computers, pagers, personal digital assistants (PDAs), instant messaginig (IM) systems, or other communication apparatuses.

Some embodiments of the invention may be implemented, for example, using a machine-readable medium or article which may store an instruction or a set of instructions that, if executed by a machine (for example, a processor or controller, PCs, and/or by other suitable machines), cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Video Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

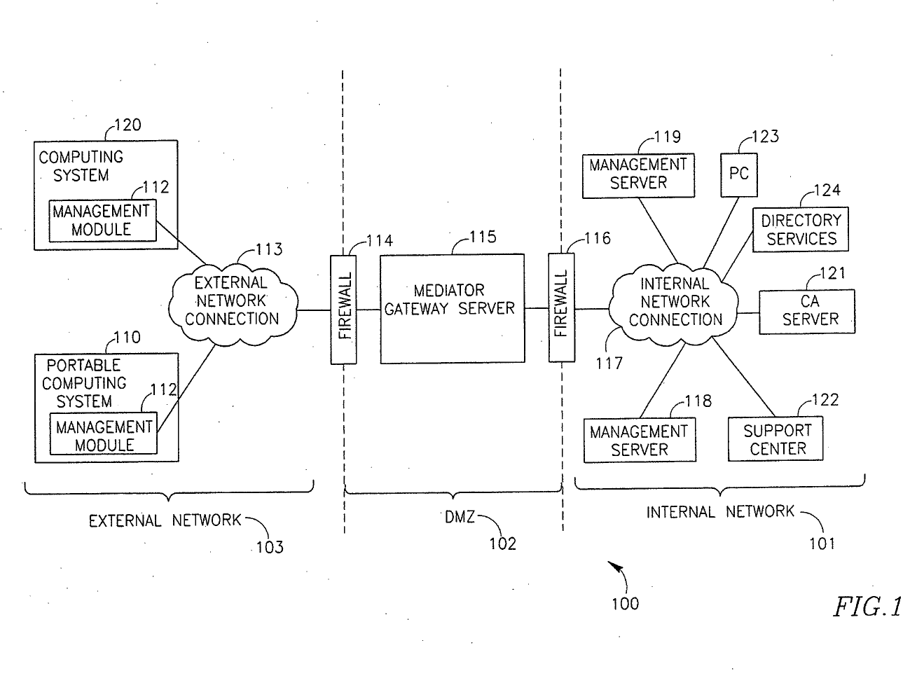

Reference is now made to FIG. 1, which is a schematic block diagram of a manageability system according to an embodiment of the present invention. Referring to FIG. 1, network 100 may include an internal network 101, a demilitarized zone (DMZ) 102 and an external network 103.

Internal network 101 may be or include a local network of any organization, institute, company and the like such as an intranet network. Any other private computer network that may securely share an organization's information or operations with, for example, its employees may be used. Internal network 101 may include one or more management servers, for example, management servers 118 and 119, capable of communicating with devices located in internal network 101 and with devices located outside internal network 101 for example as is described herein. In some embodiments of the invention, internal network 101 may include a number of servers and devices, such as but not limited to, Central Authentication (CA) server 121, directory services 124, support center 122 and a plurality of personal computers 123, which may be connected via internal network connection 117, e.g., intranet connection, to one or more management server, e.g., management servers 118 and 119.

Although in the exemplary illustration of FIG. 1, two management servers are shown, it should be understood to a person skilled in the art that the invention is not limited in this respect and according to embodiments of the present invention internal network 101 may include any suitable numbers of management servers. Although in the exemplary illustration of FIG. 1, one personal computer 123 is shown, it should be understood to a person skilled in the art that the invention is not limited in this respect and according to embodiments of the present invention internal network 101 may include any suitable numbers of personal computers 123.

DMZ 102 may be located between internal network 101 and external network 103. In some embodiments of the invention, connections from internal network 101 and external network 103 to DMZ 102 may be permitted, whereas connections from DMZ 102 may only be permitted to external network 103, e.g., servers in DMZ 102 may not connect to the internal network. This may allow DMZ 102 to provide services to both internal network 101 and external network 103 while protecting internal network 101. For example, DMZ 102 may be used for connecting servers that need to be accessible from the outside world, such as e-mail, web and Domain Name System (DNS) servers.

In some embodiments of the invention, DMZ 102 may be located between firewall 116, which may be connected to internal network 101 and firewall 114, which may be connected to external network 103. These connections may prevent, for example, accidental configurations allowing access from external network 103 to internal network 101.

DMZ 102 may include a mediator gateway server 115 which may allow management servers 118 and 119 to control and manage computing systems in external network 103 as is described in detail herein.

External network 103 may be any network located outside of internal network 101 and may include one or more computing systems 120, such as PCs and one or more portable computing systems 110, such as a laptop or a PDA, all connected via an external network connection 113, for example, the Internet network. Any other computing system may be connected.

Although in the exemplary illustration of FIG. 1, one computing system and one portable computing system are shown, it should be understood to a person skilled in the art that the invention is not limited in this respect and according to embodiments of the present invention external network 103 may include any suitable numbers of computing systems and portable computing systems.

According to some embodiments of the invention, computing systems 120 and 110 may include a management module 112. Management module 112 may allow one or more management servers, e.g., management server 118 and/or management servers 119 to remotely control and manage computing systems 120 and 110 via mediator gateway server 115. Non limiting examples for system capabilities may include: discover and repair problems in computing systems 120 and 110, download software updates and set up new computing systems. Other control and management tasks may be performed.

According to some embodiment of the invention, mediator gateway server 115 may enable communication between management servers 118 and/or 119 and management modules 112. Mediator gateway server 115 may provide, for example, a secure service to identify, authorize and communicate with remote computing systems 110 and 120. The communication may be achieved through the use of known protocols such as Transport Layer Security (TLS), Secure Sockets Layer (SSL) and the like. Mediator gateway server 115 may inform management servers 118 and 119 of the current presence state of remote computing systems 110 and 120 and may allow other proxy management operations to remote management module 112.

Management module 112 may be implemented using any suitable combination of software, firmware and/or hardware and may include memory to store hardware and/or software. Types of memory that may be used with embodiments of the present invention may include, for example, non-volatile memory such as, a Flash memory, a read only memory (ROM), magnetic computer storage devices and the like. Other types of memory may be used.

Management module 112 may allow management servers 118 and/or 119 to remotely control computing systems 120 and/or 110, for example, to investigate and discover computing systems 120 assets, to heal computing systems 120 after operating system failures and to detect problems in computing systems 120 thereby to reduce downtime of computing systems 120.

Although the scope of the present invention is not limited in this respect, management module 112 may be implemented as a subsystem, separate from the computing systems 120 or 110. The independence of management module 112 from the operating system of computing systems 120, may enable management servers, e.g., management server 118 to monitor and remotely manage computing systems 120 and 110 even if their operating systems are inoperative, or if intentional or accidental disablement of security and management capabilities in computing systems 120 or 110 occurs. In other embodiments, management module 112 may be implemented as an integrated part of the host, e.g., computing systems 120 operating system.

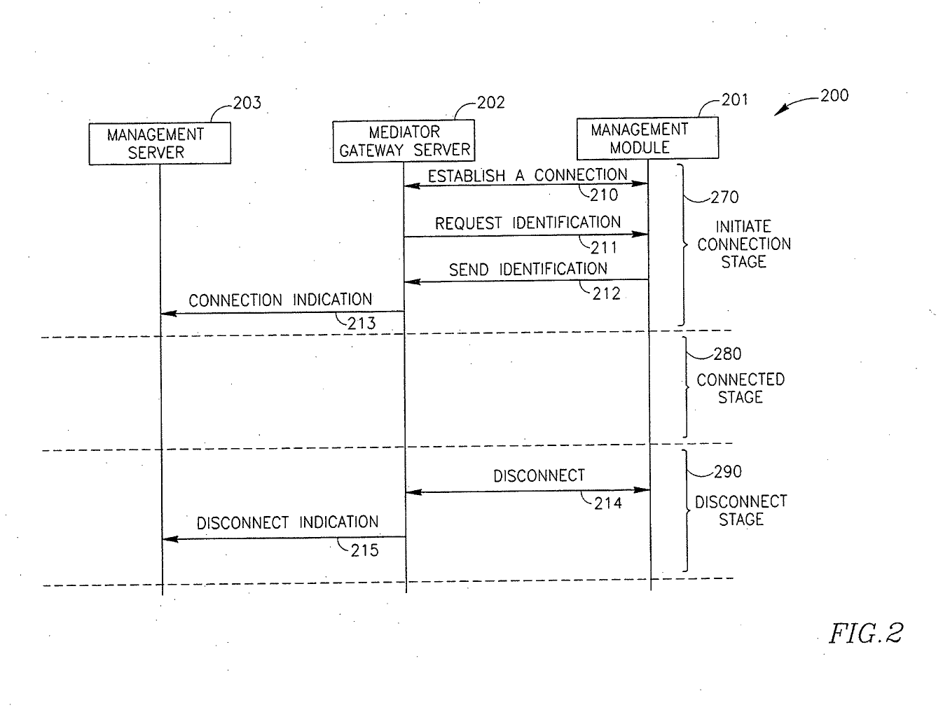

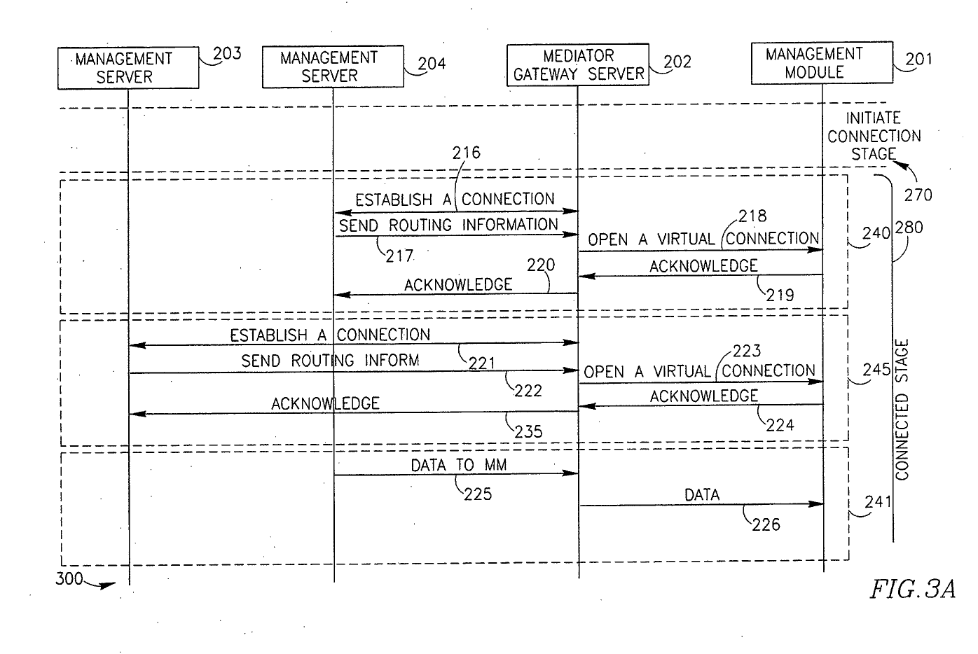

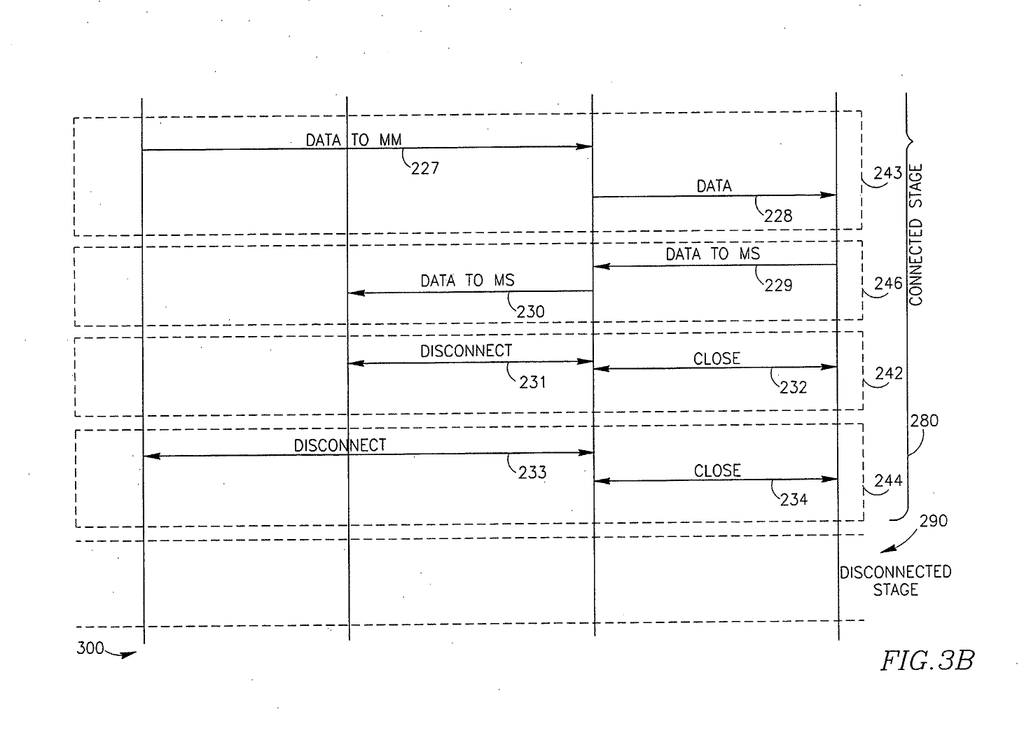

Reference is now made to FIG. 2, which is a sequence diagram of remote manageability flow according to an embodiment of the present invention. Sequence diagram 200 depicts a flow of transactions and/or messages delivered between a management module 201, e.g., management module 112 of FIG. 1, a mediator gateway server 202, e.g., mediator gateway server 115 of FIG. 1 and management server 203, e.g., management server 118 of FIG. 1. Other hardware embodiments may be used with embodiments of the present invention. A remote manageability flow may include an initiate connection stage 270, a connected stage 280 and a disconnect stage 290. During connected stage 280 management module 201 may be accessed by and may communicate with management server 203, as is described in detail with reference to FIGS. 3A and 3B.

Initiate connection stage 270 may include a connection establishment between management module 201 and mediator gateway server 202 as indicated in line 210. The connection may be initiated by management module 201 and may be established or opened using any protocol or method which may allow networked hosts to create connection to one another, over which they may exchange streams of data, for example, TCP/IP protocol. Any other protocol or method may be used. Establish connection 210 may further include use of cryptographic protocols, such as, for example Transport Layer Security (TLS), Secure Sockets Layer (SSL) or the like, which may provide secure communications and data transfers over for example, a TCP connection.

In line 211 mediator gateway server 202 may request management module 201 to identify itself, e.g., to send its Fully Qualified Domain Name (FQDN) or other identification information. Management module 201 may send the required information, e.g., its FQDN to mediator gateway server 202, as indicated in line 212. Mediator gateway server 202 may associate the value or information received in line 212 with the connection established in line 210 such that any communication with management module 201 may be performed over the connection established in line 210.

According to some embodiments of the present invention, an indication or a notification of the connection established between mediator gateway server 202 and management module 201 may be transferred from mediator gateway server 202 to management server 203 as indicated in line 213. The indication may include information of the connection and/or information regarding management module 201 and may use, for example, simple network management protocol (SNMP), Web. Service (WS) message or other protocol or method used by network management systems to monitor network-attached devices for conditions that warrant administrative attention.

Connection stage 280 may include communication between management module 201 and management server 203 over mediator gateway server 202. The communications may include transactions initiated by management module 201 and/or transactions initiated by management server 203 as is described in detail with reference to FIGS. 3A and 3B.

Disconnect stage 290 may include a disconnection of the connection established in line 210 between management module 201 and mediator gateway server 202 as indicated in line 214. The disconnection may be performed by using any protocol or method used to create the connection in line 210, for example, disconnect a TCP connection and a TLS connection. The disconnection may be initiated by management module 201 or by mediator gateway server 202.

In line 215, mediator gateway server 202 may notify management server 203 that the connection between management module 201 and mediator gateway server 202 is disconnected and may provide information of management module 201 which is no longer connected, e.g., FQDN or other identification information of management module 201 may be transferred to management server 203 to prevent management server 203 from trying to communicate with management module 201.

According to some embodiments of the present invention, the indication presented in line 215 may include information of the connection and/or information regarding management module 201 and may use, for example, simple network management protocol (SNMP), Web Service (WS) message or other protocol or method used by network management systems to monitor network-attached devices for conditions that warrant administrative attention.

Although in the exemplary illustration of FIG. 2, one management module and one management server are shown, it should be understood to a person skilled in the art that the invention is not limited in this respect and according to embodiments of the present invention any number of managements module and management servers may be used. A connection, e.g., a TCP connection, may be established between mediator gateway server 202 and each management module, e.g., as described with reference to lines 210, 211 and 212. An indication of each connection established between mediator gateway server 202 and any of the management module may be transferred from mediator gateway server 202 to any number of management servers, as is described with reference to line 213. A disconnection, e.g., a TCP disconnection may be performed between mediator gateway server 202 and each management module, e.g., as described with reference to line 214. An indication of each disconnection between mediator gateway server 202 and any of the management modules may be transferred from mediator gateway server 202 to any number of management servers, as described with reference to line 215.

Reference is now made to FIGS. 3A and 3B, which are a sequence diagram of remote manageability flow according to an embodiment of the present invention. Sequence diagram 300 depicts a flow of transactions and/or message delivering between a management module 201, e.g., management module 112 of FIG. 1, a mediator gateway server 202, e.g., mediator gateway server 115 of FIG. 1 and management servers 203 and 204, e.g., management servers 118 and 119 of FIG. 1. A remote manageability flow may include an initiate connection stage 270, as is described in detail with reference to FIG. 2, a connected stage 280 and a disconnect stage 290, as is described in detail with reference to FIG. 2.

Although the scope of the present invention is not limited in this respect, all communication between management module 201 and mediator gateway server 202 may be transported over a single channel or connection established in the initiate connection stage 270, as is described in detail with reference to FIG. 2.

For each connection established between management server 204 and/or 203 to mediator gateway server 202, mediator gateway server 202 may open a “virtual” connection, associated with the connection established in initiate connection stage 270, to management module 201, as is described in detail below in blocks 240 and 245.

In block 240 a connection may be established between management server 204 and mediator gateway server 202 as indicated in line 216, the connection may be initiated by management server 204 or by mediator gateway server 202 to allow data transfer to or from management module 201. The connection may be established or opened using any protocol or method which may allow networked hosts to create connections to one another, over which they may exchange streams of data, for example, TCP/IP protocol. Any other suitable protocol or method may be used. Connection establishment 216 may further include use of cryptographic protocols, such as, for example, TLS, SSL or the like, which may provide secure communications and data transfers over for example, a TCP connection.

As indicated in line 217, routing information may be transferred from management server 204 to mediator gateway server 202, in order for mediator gateway server 202 to identify the end entity, e.g., management module 201, requested by management server 204. The routing information may include, for example, device information in FQDN form and TCP port associated with the connection established in line 210 of initiate connection stage 270. In some embodiments of the invention, the information may be provided in an upper protocol message, for example, HTTP, HTTPS, and SOCKv5.

According to some embodiments of the invention, communications between mediator gateway server 202 and management module 201 may be transferred above the connection established in line 210 of initiate connection stage 270 of FIG. 2. As indicated in line 218, a virtual connection may be established and may be associated with the connection established in line 210 of initiate connection stage 270. The virtual connection may be created by using an open command which may be defined by any upper protocol, e.g., HTTP, HTTPS, SOCKv5 or any other protocol known in the art. The virtual connection indicated in line 218 may be initiated by gateway server 202 or by management module 201.

According to some embodiments of the invention, when the virtual connection is initiated by mediator gateway server 202, management module 201 may send an acknowledge signal or indication of the virtual connection to mediator gateway server 202 as indicated in line 219 and mediator gateway server 202 may send an acknowledge signal or indication of the virtual connection to management server 204 as indicated in line 220. The acknowledge signal indicated in lines 219 and 220 may be defined by the upper protocol used for the virtual connection opening described in line 218. When the virtual connection is initiated by management module 201, mediator gateway server 202, may send an acknowledge signal or indication of the virtual connection to management module 201.

The term “virtual connection” may refer to any communication or connection between a mediator gateway server and a management module which may use a previously established connection, e.g., a connection established in initiate connection stage 270. A virtual connection may allow a plurality of data transfers and/or message deliveries between a mediator gateway server and a management module over a single connection, e.g., a TCP connection.

In block 245 a connection may be established between management server 203 and mediator gateway server 202 as indicated in line 221, the connection may be initiated by management server 203 or by mediator gateway server 202 to allow data transfer to or from management module 201. The connection may be established or opened using any protocol or method which may allow networked hosts to create connections to one another, over which they may exchange streams of data, for example, TCP/IP protocol. Any other suitable protocol or method may be used. Connection establishment 221 may further include use of cryptographic protocols, such as, for example, TLS, SSL or the like, which may provide secure communications and data transfers over for example, a TCP connection.

As indicated in line 222, routing information may be transferred from management server 203 to mediator gateway server 202, in order for mediator gateway server 202 to identify the end entity, e.g., management module 201, requested by management server 203. The routing information may include, for example, device information in FQDN form and TCP port associated with the connection established in line 210 of initiate connection stage 270. In some embodiments of the invention, the information may be provided in an upper protocol message, for example, HTTP, HTTPS, and SOCKv5.

According to some embodiments of the invention, communications between mediator gateway server 202 and management module 201 may be transferred via the connection established in line 210 of initiate connection stage 270 of FIG. 2. As indicated in line 223, a virtual connection may be established and may be associated with the connection established in line 210 of initiate connection stage 270. The virtual connection may be created by using an open command which may be defined by any upper protocol, e.g., HTTP, HTTPS, SOCKv5 or any other protocol known in the art.

Management module 201 may send an acknowledge signal or indication of the virtual connection to mediator gateway server 202 as indicated in line 224 and mediator gateway server 202 may send an acknowledge signal or indication of the virtual connection to management server 204 as indicated in line 235. The acknowledge signal indicated in lines 224 and 235 may be defined for example by the upper protocol used for the virtual connection opening described in line 223.

According to some embodiments of the invention, once a virtual connection is established mediator gateway server 202 may forward payloads or sets of data from management server 204 to management module 201 for example as indicated in lines 225 and 226 in block 241 and from management server 203 to management module 201 as indicated in lines 227 and 228 in block 243. Mediator gateway server 202 may forward payloads or sets of data from management module 201 to management server 204 as indicated in lines 229 and 230 in block 246. Mediator gateway server 202 may forward payloads or sets of data from management module 201 to management server 203 (not shown).

Although the scope of the present invention is not limited in this respect, the data transfer described in blocks 241 and 246 may occur over the virtual connection opened in line 218 in block 240, and data transfer described in block 243 may occur over the virtual connection opened in line 223 in block 245.

In block 242 the virtual connection established in line 218 between mediator gateway server 202 and management module 201 and the connection established in line 216 between mediator gateway server 202 and management server 204 may be disconnect as indicated in lines 231 and 232. The disconnection may be initiated by management module 201 or by management server 204. The disconnect signals 231 and 232 may use the same upper protocol used for the virtual connection opening described in lines 218 and 216, e.g., HTTP, HTTPS, SOCKv5 or any other protocol known in the art.

In block 244 the virtual connection established in line 223 between mediator gateway server 202 and management module 201 and the connection established in line 221 between mediator gateway server 202 and management server 203 may be disconnect as indicated in lines 233 and 234. The disconnection may be initiated by management module 201 or by management server 203. The disconnect signals 233 and 234 may use the same upper protocol used for the virtual connection opening described in line 221 and 223, e.g., HTTP, HTTPS, SOCKv5 or any other protocol known in the art.

Although the scope of the present invention is not limited in this respect, the connection established between mediator gateway server 202 and management module 201 in initiate connection stage 270 may be used for any number of virtual connections, e.g., mediator gateway server 202 may open a virtual connection for each management server that intends to transfer data to management module 201.

Disconnect stage 290 may include a disconnection of the connection established in initiate connection stage 270 between mediator gateway server 202 and management module 201 as described in detail with reference to FIG. 2.

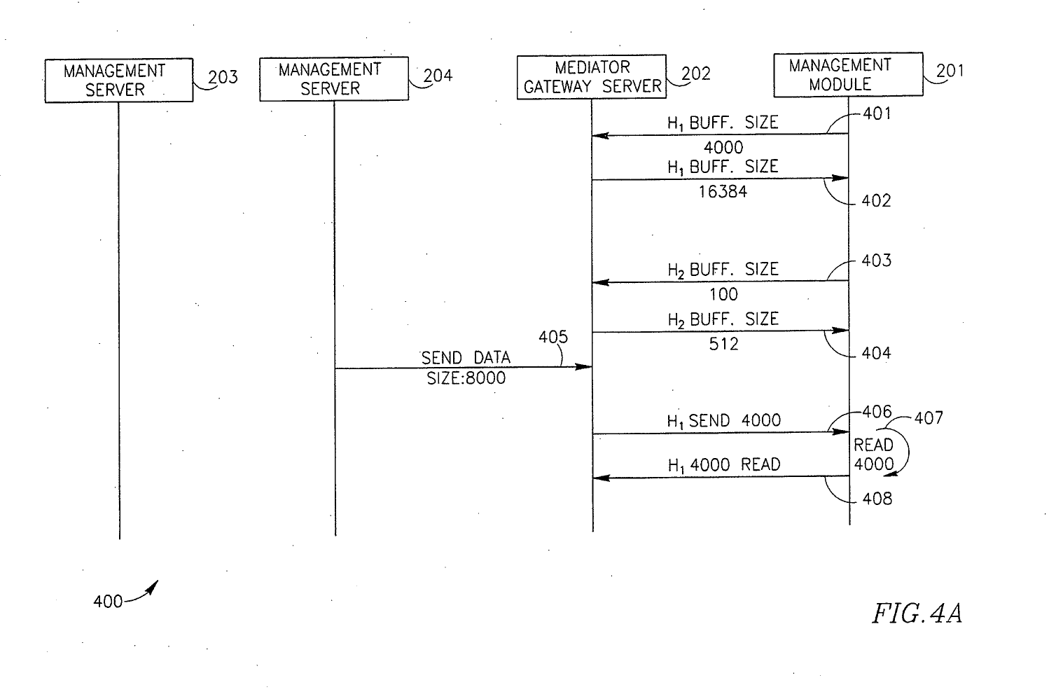

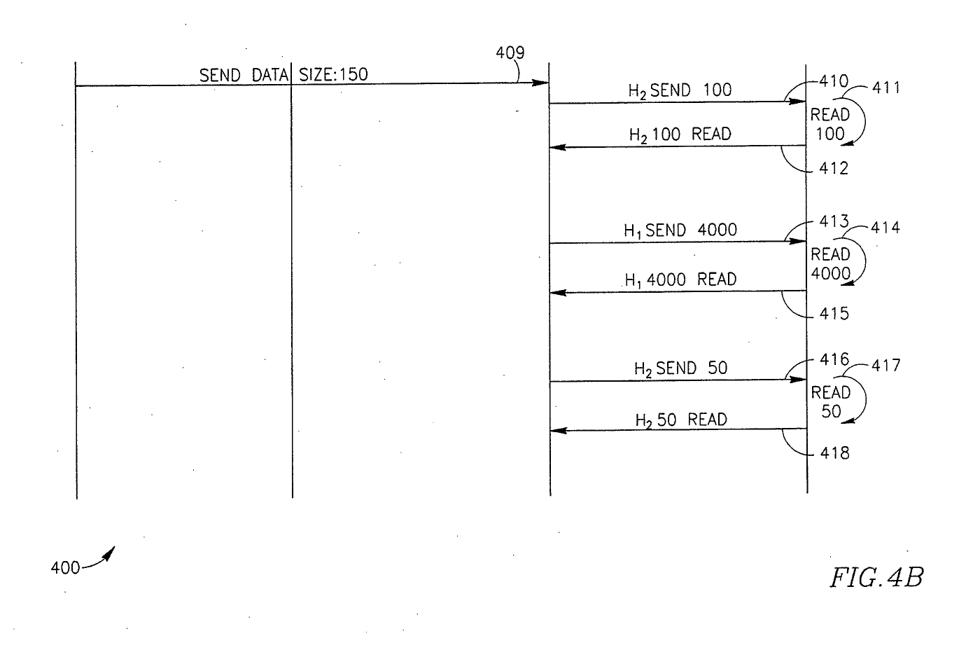

Reference is now made to FIGS. 4A and 4B, which are a sequence diagram of a remote flow control manageability according to an embodiment of the present invention. Sequence diagram 400 may depict flow control of transactions between a management module 201, e.g., management module 112 of FIG. 1, a mediator gateway server 202, e.g., mediator gateway server 115 of FIG. 1 and management servers 203 and 204, e.g., management servers 118 and 119 of FIG. 1.

According to some embodiments of the invention, a remote flow control 400 may follow an initiate connection stage e.g., initiate connection stage 270 of FIG. 2 and virtual connection establishment between mediator gateway server 202 and management module 201, as is described for example in blocks 240 and 245 of FIG. 3A.

Although the scope of the present invention is not limited in this respect, a flow control may prevent situations in which a first virtual connection may block another virtual connection from sending data to management module 201. A flow control may allow management servers 203 and 204 to control data forwarding to management module 201.

According to some embodiments of the invention, after virtual connections are established for management server 203 (also referred herein as H1) and for management servers 204 (also referred herein as H2) as described in blocks 240 and 245 of FIG. 3A, management module 201 may send an initial flow control message to mediator gateway server 202 which may indicate the buffer size available for data transferred over H1 as indicated in line 401. For example, management module 201 may indicate that the buffer size available for data that arrives over H1 is 4000 bytes. Any other buffer size may be used. Mediator gateway server 202 may send an initial flow control message to management module 201 which may indicate the buffer size available for data transferred over H1 as indicated in line 402. For example, mediator gateway server 201 may indicate that the buffer size available for data to be sent over H1 is 16,384 bytes. Any other buffer size may be used.

Management module 201 may send an initial flow control message to mediator gateway server 202 which may indicate the buffer size available for data transferred over H2 as indicated in line 403. For example, management module 201 may indicate that the buffer size available for data arrives over H2 is 100 bytes. Any other buffer size may be used. Mediator gateway server 202 may send an initial flow control message to management module 201 which may indicate the buffer size available for data transferred over H2 as indicated in line 404. For example, mediator gateway server 202 may indicate that the buffer size available for data to be sent over H1 is 512 bytes. Any other buffer size may be used.

Management server 204 may send data over H1 as indicated in line 405, for example, the buffer size of the data transferred may be 8000 bytes. Any other buffer size may be used. Mediator gateway server 202 may transfer to management module 201 only for example 4,000 bytes from the original 8,000 byte payload arrived from management server 204 as indicated in line 406, based on the initial flow control message arrived from management module 201 in line 401. As indicated in line 407 management module 201 may read the 4,000 bytes arrived from management server 204 over H1 and may send a flow control message indicating that 4,000 bytes have been read by management module 201 as indicated in line 408. Any other package or transfer sizes, or subsets of transfer sizes, may be used.

Management server 203 may send data over H2 as indicated in line 409, for example, the buffer size of the data transferred may be 150 bytes. As with other specific parameters discussed herein, buffer sizes other than 150 may be used. Mediator gateway server 202 may transfer to management module 201 only 100 bytes from the original message arrived from management server 203 as indicated in line 410, based on the initial flow control message arrived from management module 201 in line 403. As indicated in line 411 management module 201 may read the 100 bytes arrived from management server 203 over H2 and may send a flow control message indicating that 100 bytes have been read by management module 201 as indicated in line 412.

Mediator gateway server 202 may transfer to management module 201 the last 4,000 bytes from the original message arrived from management server 204 as indicated in line 413, based on the flow control message arrived from management module 201 in line 408. As indicated in line 414 management module 201 may read the last 4,000 bytes arrived from management server 204 over H1 and may send a flow control message indicating that 4,000 bytes have been read by management module 201 as indicated in line 415. Here and elsewhere, specific transfer or other specific sizes are provided for example only, and other data group or package sizes may be transferred, stored or analyzed.

Mediator gateway server 202 may transfer to management module 201 the last 50 bytes from the original message arrived from management server 203 as indicated in line 416, based on the flow control message arrived from management module 201 in line 412. As indicated in line 417 management module 201 may read the last 50 bytes arrived from management server 204 over H2 and may send a flow control message indicating that 50 bytes have been read by management module 201 as indicated in line 418.

Although in the exemplary illustration of FIGS. 4A and 4B, two management servers and two virtual connections are described, it should be understood to a person skilled in art that the invention is not limited in this respect and according to embodiments of the present invention may include any suitable numbers of management servers and virtual connections.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A management communication system comprising:
a management server in a first network to communicate with a management module of a computing system in a second network;
a mediator server to establish a communication connection to the management module; and
to transfer data arrived from the management server to the management module wherein the transfer is associated with the communication connection.

2. The system of claim 1, wherein the communication connection is established for a communication connection between the a management server and the mediator server

3. The system of claim 1, wherein the management server comprises a plurality of management servers.

4. The system of claim 1, wherein the management module comprises a plurality of management modules.

5. The system of claim 1, wherein the communication connection comprises a TCP connection.

6. The system of claim 1, wherein the first network is a local area network.

7. The system of claim 6, wherein the management server in the local area network is to control a management module of a computing system outside the local area network.

8. A method comprising:
establishing a communication connection between a mediator server and a management module of a computing system in a first network; and
transferring data from a management server in a second network to the management module via the mediator server wherein the transferring is associated with the communication connection.

9. The method of claim 8, wherein the communication connection is established for a connection established between the management server and the mediator server.

10. The method of claim 8, wherein the management server comprises a plurality of management servers.

11. The method of claim 8, wherein the management module comprises a plurality of management modules.

12. The method of claim 8, wherein the communication connection comprises a TCP connection.

13. The method of claim 8, wherein the second network is a local area network.

14. The method of claim 8, wherein transferring data comprises controlling the management module by the management server.

15. The system of claim 1 comprising: a storage medium, having stored thereon instructions, that when executed, result in:
communicating over a mediator server between a management server in a first network and a management module of a computing system in a second network.
